(19) United States
(12) Patent Application Publication
(10) Pub. No.: US 2024/0063477 A1
(43) Pub. Date: Feb. 22, 2024

(54) Secondary Battery, Method for Manufacturing the Same and Battery Pack

(71) Applicant: LG Energy Solution, Ltd., Seoul (KR)

(72) Inventors: Koo Seung Chung, Daejeon (KR); Sang Seung Oh, Daejeon (KR); Hye Hyeon Kim, Daejeon (KR); Kyung Eun Sun, Daejeon (KR); Kyu Tae Park, Daejeon (KR)

(73) Assignee: LG Energy Solution, Ltd., Seoul (KR)

(21) Appl. No.: 18/269,710

(22) PCT Filed: Aug. 22, 2022
(86) PCT No.: PCT/KR2022/012539

§ 371 Date: Jun. 26, 2023

(30) Foreign Application Priority Data
Aug. 24, 2021 (KR) 10-2021-0111973
Aug. 19, 2022 (KR) 10-2022-0104340

(51) Int. Cl. H01M 50/105; H01M 50/171; H01M 50/164; H01M 50/159; H01M 10/613; H01M 10/647; H01M 10/6551; H01M 10/04

(52) U.S. Cl. CPC H01M 50/105; H01M 50/171; H01M 50/164; H01M 50/159; H01M 10/613; H01M 10/647; H01M 10/6551; H01M 10/04

(57) ABSTRACT

A secondary battery including an electrode assembly and a pouch configured to accommodate the electrode assembly. The pouch includes two first covers provided on both surfaces of the electrode assembly in a thickness direction and two second covers provided on both surfaces of the electrode assembly in a full-width direction. The edge surfaces of the first covers and the second covers are sealed by a first sealing part, and the end surfaces of the first covers and the second covers are sealed by a second sealing part. The two second covers are in close contact with both the surfaces of the electrode assembly in the full-width direction.

### CROSS-REFERENCE TO RELATED APPLICATION

The present application is a national phase entry under 35 U.S.C. § 371 of International Application No. PCT/KR2022/012539 filed on Aug. 22, 2022, which claims priority from Korean Patent Application Nos. 10-2021-0111973, filed on Aug. 24, 2021, and 10-2022-0104340, filed on Aug. 19, 2022, all of which are hereby incorporated herein by reference in their entirety.

### TECHNICAL FIELD

The present invention relates to a secondary battery, a method for manufacturing the same and a battery pack, and more particularly, to a secondary battery including a pouch having a novel structure in which cooling air transfer efficiency is improved, a method for manufacturing the same, and a battery pack.

### BACKGROUND ART

In general, secondary batteries refer to chargeable and dischargeable, unlike primary batteries that are not chargeable. The secondary batteries are being widely used for mobile phones, notebook computers, and camcorders, electric vehicles, and the like.

The secondary batteries are classified into a can-type secondary battery, in which an electrode assembly is embedded in a metal can, and a pouch-type secondary battery, in which an electrode assembly is embedded in a pouch.

The cylindrical secondary battery includes an electrode assembly having a structure in which an electrode and a separator are wound in a jelly-roll shape, a can accommodating the electrode assembly, and a cap assembly mounted in an opening of the can.

The pouch-type secondary battery includes an electrode assembly in which electrodes and separators are alternately disposed, and a pouch accommodating the electrode assembly, and the pouch includes an accommodation part accommodating a monocell and a sealing part sealing the accommodation part.

The electrodes includes a positive electrode and a negative electrode.

The above-described pouch-type secondary battery may be manufactured in various forms because the electrode assembly in which the electrodes and the separators are alternately disposed and also may be easily changed in size and capacity. In addition, it is advantageous of improving energy density because a space of the pouch-type secondary battery is efficiently utilized.

In addition, the pouch is provided with a double side folding (DSF) part that seals an end of the sealing part in a double-folded state so as to increase in sealing force.

A battery pack provided with the pouch-type secondary battery having the above-described structure is provided. The battery pack includes a battery module provided to be disposed in a thickness direction and a cooling member provided on a side portion of the battery module to cool the plurality of pouch-type secondary batteries.

However, the battery pack has a problem in that since the sealing part of the pouch is provided as the DSF part, cold air of the cooling member is not sufficiently transferred to the accommodation part of the pouch. That is, since the DSF part is disposed between the cooling member and the accommodation part of the pouch, the cooling member and the accommodation part may not be in close contact with each other. Thus, the cold air of the cooling member may not be directly transferred to the accommodation part, and thus, it is a limit in improving the cooling air transfer efficiency.

### DISCLOSURE OF THE INVENTION

### Technical Problem

An object of the present invention for solving the above problem is to provide a secondary battery in which a pouch having a novel structure is implemented to improve simplification of a process, and in particular, a cooling member and an accommodation part of the pouch are in close contact with each other, and thus, cool air of the cooling member is directly transferred to the accommodation part of the pouch to improve cooling air transfer efficiency, a method for manufacturing the same, and a battery pack.

### Technical Solution

An aspect of a secondary battery of the present disclosure for achieving the above object includes: an electrode assembly; and a pouch configured to accommodate the electrode assembly, wherein the pouch includes: two first covers provided on both surfaces of the electrode assembly in a thickness direction, respectively; two second covers provided on both surfaces of the electrode assembly in a full-width direction, respectively, wherein edge surfaces of the first cover and the second cover, which face each other, are sealed by a first sealing part, end surfaces of the first cover and the second cover, which are directed in the same direction, are sealed by a second sealing part, and the two second covers are in close contact with on both the surfaces of the electrode assembly in the full-width direction.

The sealing part may be provided by sealing the edge surfaces of the first cover and the second cover, which face each other, and the first sealing part may be bent to be in close contact with a surface of the first cover.

The secondary battery may further include an adhesive layer through which the first sealing part adheres to the surface of the first cover.

The second sealing part may be provided by sealing the end surfaces of the two first covers, wherein the end surface of the second cover may be inserted between the end surfaces of the two first covers so as to be sealed together with the end surfaces of the first covers.

The first cover may have a structure in which a protective layer, a first metal layer, and an insulating layer are sequentially disposed from the inside to the outside, and the second cover may have a structure in which a protective layer, a second metal layer, and an insulating layer are sequentially disposed from the inside to the outside, wherein the second metal layer may have thermal conductivity greater than that of the first metal layer.

The first metal layer may be made of copper (Cu), and the second metal layer may be made of aluminum (Al).

In another aspect, a method for manufacturing a secondary battery according to the present disclosure includes: disposing two first covers that cover both surfaces of an electrode assembly in a thickness direction, respectively, and disposing two second covers that cover both surfaces of the electrode assembly in a full-width direction, respectively; a primary manufacturing process of forming a first sealing part that seals edge surfaces of the first cover and the second cover, which face each other, to manufacture a semi-assembled pouch; an accommodation process of accommodating the electrode assembly in the semi-assembled pouch; and a secondary manufacturing process of forming a second sealing part that seals end surfaces of the first cover and second cover, which are directed in the same direction, provided in the semi-assembled pouch to manufacture an assembled pouch, wherein, when the electrode assembly is accommodated in the semi-assembled pouch in the accommodation process, the two second covers are in close contact with both the surfaces of the electrode assembly in the full-width direction, respectively.

In the primary manufacturing process, the first sealing part may be formed by sealing the edge surfaces of the first cover and the second cover, which face each other, in a state of being in close contact with each other.

In the secondary manufacturing process, the second sealing part may be formed by folding the end surfaces of the two second covers to insert the folded end surfaces between the end surfaces of the two first covers and then thermally fusing the end surfaces of the two first covers to seal the end surfaces of the two first covers together with the end surfaces of the two second covers.

The method may further include, after the secondary manufacturing process, a bending process of bending the first sealing part to be in close contact with a surface of the first cover.

The bending process may further include a process of allowing the first sealing part to adhere to the surface of the first cover through an adhesive layer.

In the disposing process, the first cover may have a structure in which a protective layer, a first metal layer, and an insulating layer are sequentially disposed from the inside to the outside, and the second cover has a structure in which a protective layer, a second metal layer, and an insulating layer are sequentially disposed from the inside to the outside, wherein the second metal layer may have thermal conductivity greater than that of the first metal layer.

A battery pack of the present invention includes a battery module in which the secondary battery is provided in plurality, wherein the plurality of secondary batteries may be provided as the battery module in which first covers of a pouch are arranged to correspond to each other.

The battery pack may further include a cooling member that cools the battery module, wherein the cooling member may be provided to be in close contact with second covers of the pouch.

A heat dissipation pad may be further provided between the plurality of secondary batteries.

### Advantageous Effects

The secondary battery of the present invention may include the pouch provided with the two first covers and the second-second covers. Here, the edge surfaces of the first cover and the second cover, which face each other, may be sealed by the first sealing part, and the end surfaces of the first cover and the second cover, which are directed in the same direction, may be sealed by the second sealing part. Due to these characteristics, the pouch having the novel structure may be manufactured. Particularly, the sealing part may be provided on the edge of the pouch so that the cooling member and the second cover of the pouch are in surface contact with each other to improve the cooling properties.

### BRIEF DESCRIPTION OF THE DRAWINGS

FIG. 1 is a perspective view of a secondary battery according to a first embodiment of the present invention.

FIG. 2 is an exploded perspective view illustrating a pouch of the secondary battery according to the first embodiment of the prevent invention.

FIG. 3 is a cross-sectional view of the secondary battery according to the first embodiment of the present invention.

FIG. 4 is an enlarged view of a portion A illustrated in FIG. 3.

FIG. 5 is a front view of the secondary battery according to the first embodiment of the present invention.

FIG. 6 is a cross-sectional view illustrating a stack structure with respect to a first cover according to the present invention.

FIG. 7 is a cross-sectional view illustrating a stack structure with respect to a second cover according to the present invention.

FIG. 8 is a flowchart illustrating a method for manufacturing the secondary battery according to the first embodiment of the present invention.

FIG. 9 is a perspective view illustrating a disposing process in the method for manufacturing the secondary battery according to the first embodiment of the present invention.

FIG. 10 is a perspective view illustrating a primary manufacturing process in the method for manufacturing the secondary battery according to the first embodiment of the present invention.

FIG. 11 is a front view illustrating an accommodation process in the method for manufacturing the secondary battery according to the first embodiment of the present invention.

FIG. 12 is a perspective view illustrating a secondary manufacturing process in the method for manufacturing the secondary battery according to the first embodiment of the present invention.

FIG. 13 is a perspective view illustrating a bending process in the method for manufacturing the secondary battery according to the first embodiment of the present invention.

FIG. 14 is a side view of a battery pack according to a second embodiment of the present invention.

### DETAILED DESCRIPTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

### Secondary Battery According to First Embodiment of the Present Invention

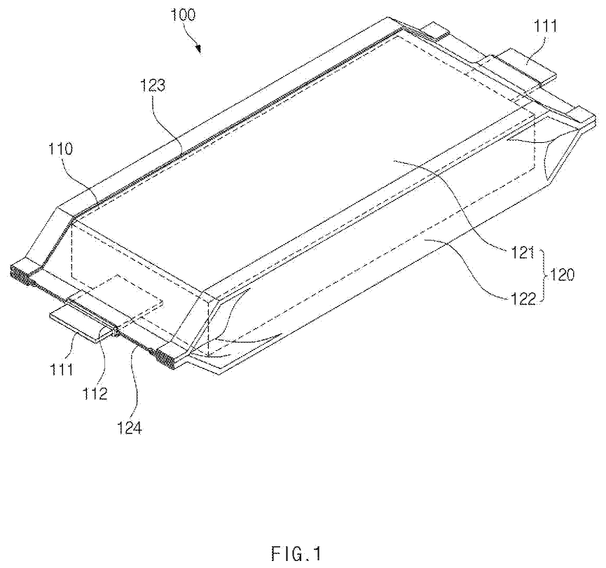

As illustrated in FIG. 1, a secondary battery 100 according to a first embodiment of the present invention includes an electrode assembly 110 and a pouch 120 accommodating the electrode assembly 110.

Electrode Assembly

The electrode assembly 110 has a structure in which electrodes and separators are alternately disposed. In addition, the electrode assembly 110 includes an electrode tab provided on each of the electrode, an electrode lead 111 coupled to the electrode tab, and a lead film 112 provided on the electrode lead 111.

Pouch

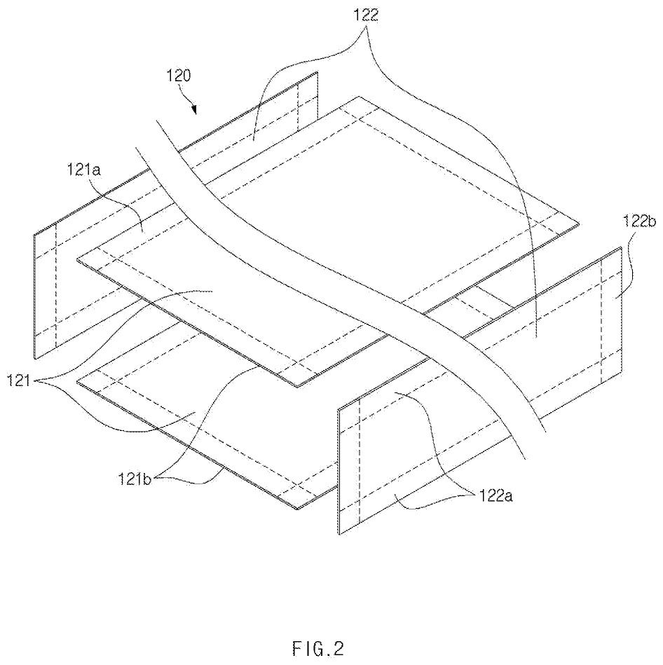

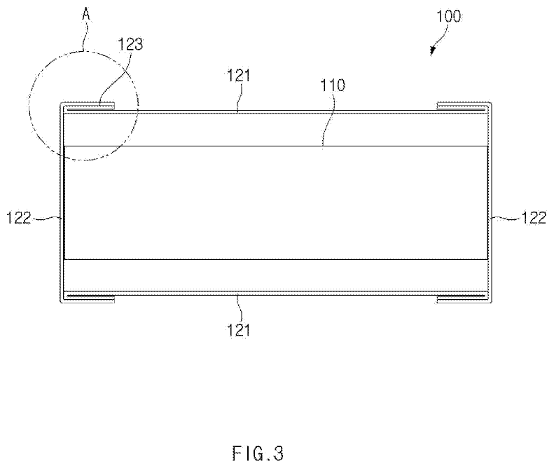

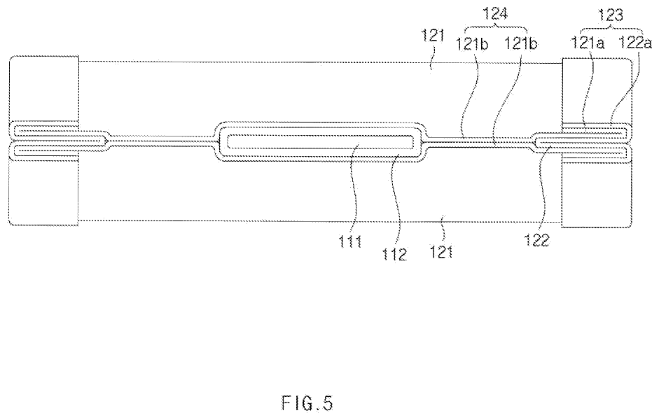

As illustrated in FIGS. 2 to 5, the pouch 120 is configured to sealingly accommodate the electrode assembly 110 and includes two first covers 121 respectively provided on both surfaces (top and bottom surfaces of the electrode assembly when viewed in FIG. 1) of the electrode assembly in a thickness direction and two second covers 122 respectively provided on both surfaces (left and right surfaces of the electrode assembly when viewed in FIG. 1) of the electrode assembly 110 in a full-width direction.

The first covers 121 are horizontally disposed on both the surfaces of the electrode assembly 110 in a vertical direction as illustrated in FIG. 1. In addition, each of the first covers 121 has a first edge surface 121a on each of both sides of the electrode assembly 110 in the full-width direction when viewed in FIG. 2 and a first end surface 121b on each of both ends of the electrode assembly 110 in a full-length direction when viewed in FIG. 2.

The second covers 122 are vertically disposed on both surface of the electrode assembly 110 in a left and right direction, respectively, when viewed in FIG. 1. In addition, each of the second covers 122 has a second edge surface 122a on each of both sides of the electrode assembly 110 in the vertical direction when viewed in FIG. 2 and a second end surface 121b on each of both ends of the electrode assembly 110 in the full-length direction when viewed in FIG. 2.

Here, the edge surfaces of the first cover 121 and the second cover 122, which face each other, have the same length for ease of sealing.

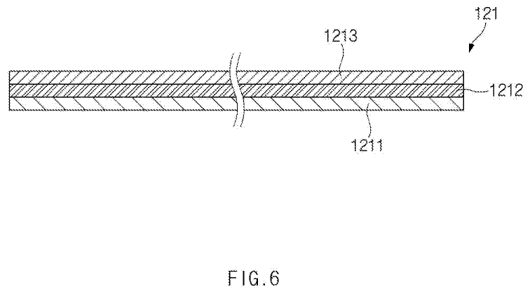

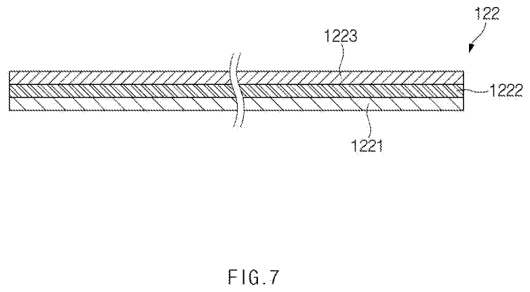

As illustrated in FIGS. 6 and 7, the first cover 121 has a structure in which a resin layer 1211, a metal layer 1212, and an insulating layer 1213 are stacked outward from the inside of the pouch. In addition, the second cover 122 has a structure in which a resin layer 1221, a second metal layer 1222, and an insulating layer 1223 are stacked inward from the inside of the pouch. Particularly, each of the first cover 121 and the second cover 122 have a rectangular film shape as illustrated in FIG. 2.

Here, the resin layer of the first cover and the resin layer of the second cover are made of the same material, and the insulating layer of the first cover and the insulating layer of the second cover are made of the same material. However, the first metal layer of the first cover and the metal layer of the second cover are made of different materials.

The two first covers have the same size. Alternatively, the two first covers may have different sizes depending on the stack structure of the electrode assembly. The two second covers have the same size. Alternatively, the two first covers may have different sizes depending on the stack structure of the electrode assembly.

Each of the first covers may be provided with two or more pouch films. That is, the first cover may be manufactured by connecting two or more pouch films according to an area of the electrode assembly.

The second cover may be provided with two or more pouch films. That is, the first cover may be manufactured by connecting two or more pouch films according to a thickness of the electrode assembly.

Here, each of the first cover 121 and the second cover 122 has a sealing structure that sealingly accommodates the electrode assembly 110. That is, the edge surfaces of the first cover 121 and the second cover 122, which face each other, are sealed by the first sealing part 123 to seal an edge surface of the pouch 120, and the end surfaces of the first cover 121 and the second cover 122, which are directed in the same direction, are sealed by the second sealing part 124 to seal front and rear surfaces of the electrode assembly 110.

That is, the first sealing part 123 is provided by sealing the first edge of the first cover 121 and the second edge of the second cover 122, which face each other, in a state of being in close contact with each other. Here, the first sealing part may be coated with an insulating material to improve insulation.

The second sealing part 124 is provided while the two first end surfaces 121b are sealed, and the second end surfaces 122b disposed on the two second covers 122 are provided to be sealed together with the end surface of the first cover 121 while being inserted between the first end surfaces 121b disposed on the two first cover 121. That is, the second sealing portion 124 is provided while the two first end surfaces 121b and the two second end surfaces 122b are sealed together.

In other words, the pouch 120 having an electrode assembly accommodation space may be manufactured while the two first covers 121 and the two second covers 122 are sealed by the first sealing part 123 and the second sealing part 124.

Here, the two second covers 122 may be provided to be in close contact with both the surfaces of the electrode assembly in a full-width direction, respectively. Thus, heat generated in the electrode assembly may be directly quickly released to the outside by the second cover, and as a result, the electrode assembly may be greatly suppressed from increasing in temperature.

The second metal layer 1222 of the second cover may be made of a metal material having thermal conductivity greater than that of the first metal layer 1212 of the first cover. For example, the first metal layer is made of copper (Cu), and the second metal layer is made of aluminum (Al), which has thermal conductivity greater than that of copper (Cu). That is, the present application is characterized in that the second metal layer of the second cover is applied as a metal having thermal conductivity greater than that of the first metal layer of the first cover, and due to this characteristic, the heat generated in the electrode assembly may be quickly released to the outside while being transferred to the second cover.

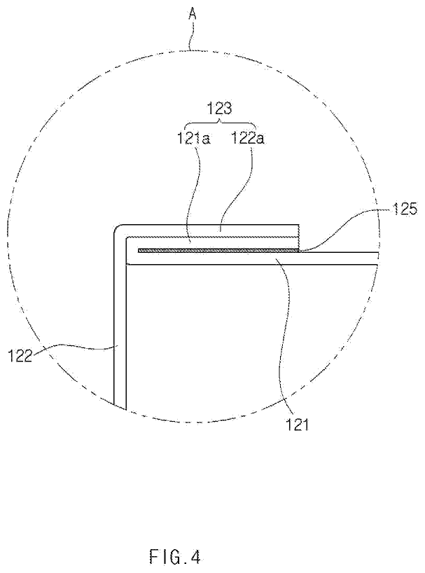

Referring to FIG. 4, the first sealing part 123 of the pouch 120 may be in contact with a surface of the first cover 121 while being in a direction of the first cover 121, and thus, the electrode assembly 110 may be reduced in volume, and an exposed area of an outer circumferential surface of the second cover 122 may be more largely secured. This allows the cooling member to be in close contact with the surface of the second cover 122, thereby securing a large contact area, and thus, cold air of the cooling member may be directly transferred to the surface of the pouch 120 to improve cold air transfer efficiency.

The pouch 120 further includes an adhesive layer 125. Here, the adhesive layer 125 is provided between the first sealing part 123 and the first cover 121, and the first sealing part 123 adheres to the surface of the first cover 121. Thus, the first sealing part 123 may be attached to the surface of the first cover 121 so as not to be separated.

Since the pouch 120 having such a configuration includes the two first covers 121 and the two second covers 122, there is no need to perform a separate forming process, and thus, the pouch 120 having a novel structure may be implemented Particularly, the process may be improved in simplification, and as a result, workability and efficiency may be improved. Furthermore, an externally exposed area of the second cover 122, which is a side portion of the pouch, may increase to improve adhesion with the cooling member, thereby improving the cold air transfer efficiency.

Thus, in the secondary battery 100 according to the first embodiment of the present invention, the pouch 120 having the novel structure and including the first cover, the second cover, the first sealing part, and the second sealing part may be manufactured, and thus, the simplification of the process may be improved, and in particular, the adhesion with the cooling device may increase to improve the cold air transfer efficiency.

Hereinafter, a method for manufacturing the secondary battery according to the first embodiment of the present invention will be described.

### Method for Manufacturing Secondary Battery According to First Embodiment of the Present Invention

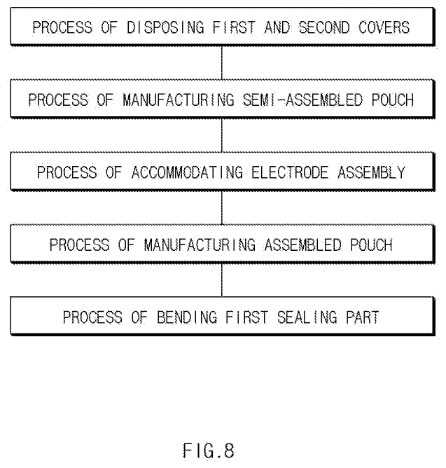

As illustrated in FIG. 8, a method for manufacturing the secondary battery according to the present invention includes a disposition process, a primary manufacturing process, an accommodation process, a secondary manufacturing process, and a bending process.

Disposition Process

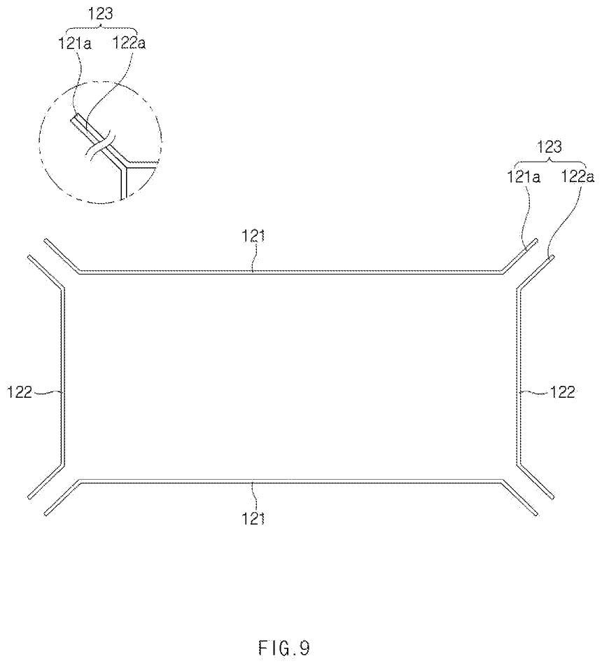

In the disposing process, as illustrated in FIG. 9, each of two first covers 121 covering both surfaces of the electrode assembly 110 in a thickness direction is disposed. Next, each of two second covers 122 covering both surfaces of the electrode assembly 110 in a full-width direction is disposed.

Here, each of the first covers 121 has a first edge surface 121a on each of both sides of the electrode assembly 110 in a full-width direction when viewed in FIG. 2 and a first end surface 121b on each of both ends of the electrode assembly 110 in a full-length direction when viewed in FIG. 2. Each of the second covers 122 has a second edge surface 122a on each of both sides of the electrode assembly 110 in the vertical direction when viewed in FIG. 2 and a second end surface 121b on each of both ends of the electrode assembly 110 in the full-length direction when viewed in FIG. 2.

The edge surfaces of the first cover 121 and the second cover 122, which face each other, have the same length.

Referring to FIGS. 6 and 7, the first cover 121 has a structure in which a resin layer 1211, a metal layer 1212, and an insulating layer 1213 are stacked outward from the inside of the pouch. In addition, the second cover 122 has a structure in which a resin layer 1221, a second metal layer 1222, and an insulating layer 1223 are stacked inward from the inside of the pouch.

The second metal layer 1222 of the second cover may be made of a metal material having thermal conductivity greater than that of the first metal layer 1212 of the first cover. For example, the first metal layer is made of copper (Cu), and the second metal layer is made of aluminum (Al), which has thermal conductivity greater than that of copper (Cu).

Primary Manufacturing Process

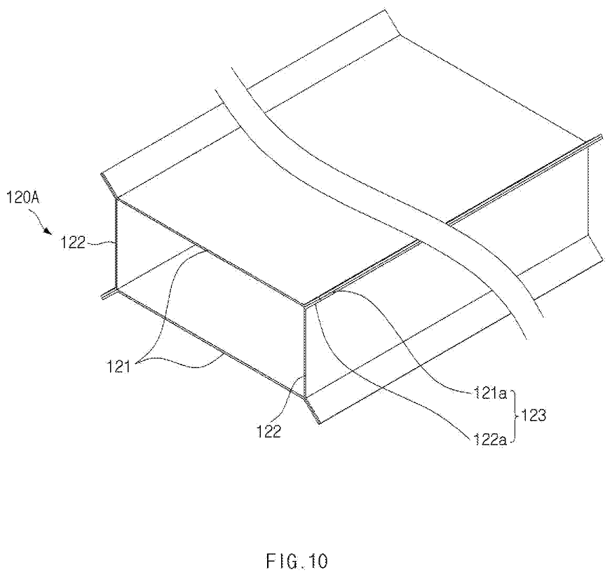

As illustrated in FIG. 10, in the primary manufacturing process, a first sealing part 123 sealing edge surfaces of the first cover 121 and the second cover 122, which face each other, is formed to manufacture a semi-assembled pouch 120A. Here, the first sealing part 123 is formed by sealing the edge surfaces of the first cover 121 and the second cover 122, which face each other, in a state of being in close contact with each other. Then, the semi-assembled pouch 120A having a rectangular frame shape may be manufactured.

Accommodation Process

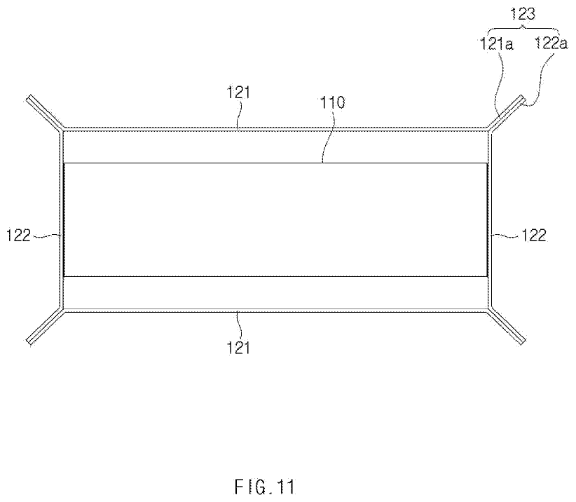

In the accommodation process, as illustrated in FIG. 11, the electrode assembly 110 is accommodated in the semi-assembled pouch 120A.

Here, when the electrode assembly 110 is accommodated in the semi-assembled pouch 120A, the two second covers 122 are in close contact with both the surfaces of the electrode assembly 110 in the full-width direction, respectively. Thus, heat generated in the electrode assembly due to the close contact between the second cover and the electrode assembly may be quickly absorbed to the second cover and then released to the outside, and as a result, the electrode assembly may be greatly suppressed from increasing in temperature.

Particularly, since the second metal layer provided in the second cover is made of aluminum, thermal conductivity may be improved, and as a result, the electrode assembly may be greatly suppressed from increasing in temperature.

Secondary Manufacturing Process

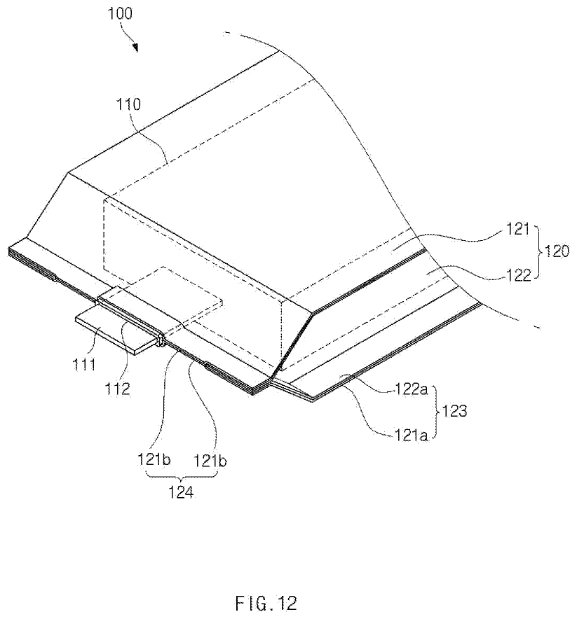

In the secondary manufacturing process, as illustrated in FIG. 12, a second sealing part 124 that seals end surfaces of the first cover 121 and the second cover 122, which are directed in the same direction, provided in the semi-assembled pouch 120A is formed to manufacture an assembled pouch 120 (hereinafter, referred to a pouch).

That is, the end surfaces of the two second covers 122 are folded and then inserted between the end surfaces of the two first covers 121. Next, the end surfaces of the two first covers 121 are in close contact with each other. Next, the end surfaces of the two first covers 121 are thermally fused to be sealed together with the end surfaces of the two second covers 122. Then, the second sealing part 124 may be manufactured.

After the secondary manufacturing process, the method may further include a bending process of selectively bending the first sealing part 123 to adhere to the surface of the first cover 121.

Bending Process

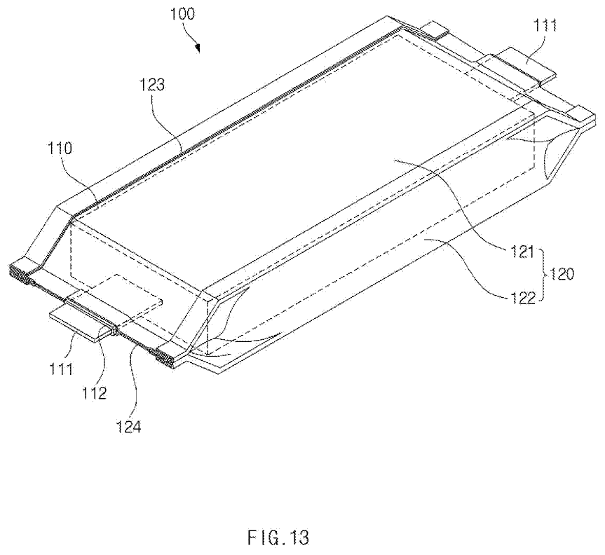

In the bending process, as illustrated in FIG. 13, the first sealing part 123 is bent toward the first cover 121 so as to be in close contact with the surface of the first cover 121.

Here, the bending process may further include a process of bonding the first sealing part 123 to the surface of the first cover 121 through the adhesive layer 125 to increase in fixing force of the first sealing part 123.

When the above processes are completed, the secondary battery 100 as illustrated in FIG. 1 may be manufactured.

Hereinafter, in descriptions of another embodiment of the present invention, constituents having the same function as the above-mentioned embodiment have been given the same reference numeral in the drawings, and thus duplicated description will be omitted.

### Battery Pack According to Second Embodiment of the Present Invention

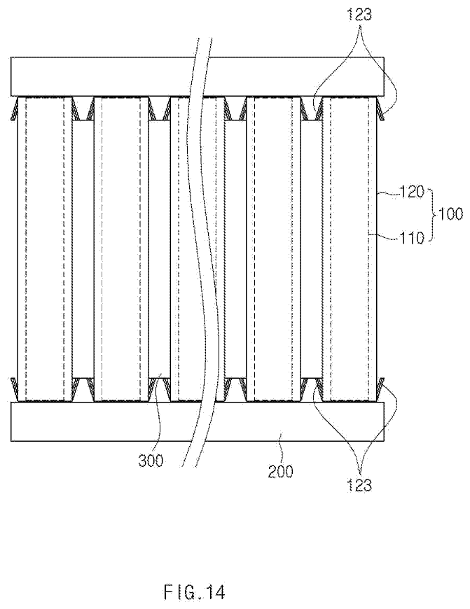

A battery pack according to a second embodiment of the present invention includes a plurality of secondary batteries 100 as illustrated in FIG. 14. Here, each of the secondary batteries 100 includes an electrode assembly 110 and a pouch 120, and the pouch 120 includes two first covers 121 respectively provided on both surfaces of the electrode assembly 110 in a thickness direction, and two second covers 122 respectively provided on both surfaces of the electrode assembly 110 in a full-width direction.

The secondary battery 100 has the same configuration and function as the secondary battery described in the first embodiment, and thus overlapping descriptions will be omitted.

Therefore, since the battery pack according to the second embodiment of the present invention includes the pouch 120 having a novel structure, simplification of the manufacturing and process may be improved, and productivity may be improved.

The battery pack according to the second embodiment of the present invention includes a cooling member 200 that cools a battery module, and the cooling member 200 is in close contact with the second cover 122 of the pouch 120.

Here, the cooling member 200 may be in a surface contact with the second cover 122 of the pouch 120, and thus, cold air generated from the cooling member 200 may be directly transferred to the second cover 122, thereby improving cold air transfer efficiency.

The battery pack according to the second embodiment of the present invention further includes a heat dissipation pad 300 provided between the plurality of secondary batteries 100, and the heat dissipation pad 300 may release heat generated from the secondary batteries 100 to improve the cooling efficiency.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

100: Secondary battery
110: Electrode assembly
111: Electrode lead
112: Lead film
120: Pouch
121: First cover
121a: First edge surface
121b: First end surface
122: Second cover
122a: Second edge surface
122b: Second end surface
123: First sealing part
124: Second sealing part
125: Adhesive layer
200: Cooling member
300: Heat dissipation pad

1. A secondary battery comprising:
an electrode assembly; and
a pouch configured to accommodate the electrode assembly,
wherein the pouch comprises:
two first covers provided on both surfaces of the electrode assembly in a thickness direction, respectively;
two second covers provided on both surfaces of the electrode assembly in a full-width direction, respectively,
wherein edge surfaces of the two first covers and the two second covers are sealed by a first sealing part,
end surfaces of the two first covers and the two second covers are sealed by a second sealing part, and
the two second covers are in close contact with both surfaces of the electrode assembly in the full-width direction.

2. The secondary battery of claim 1, wherein the first sealing part is provided by sealing the edge surfaces of the two first covers with the edge surfaces of the two second covers which face each other, and
the first sealing part is bent to be in close contact with a surface of the first cover.

3. The secondary battery of claim 2, further comprising an adhesive layer through which the first sealing part adheres to the surface of the first cover.

4. The secondary battery of claim 1, wherein the second sealing part is provided by sealing the end surfaces of the two first covers,
wherein the end surfaces of the two second covers are inserted between the end surfaces of the two first covers so as to be sealed together with the end surfaces of the first covers.

5. The secondary battery of claim 1, wherein the two first covers have a structure in which a first protective layer, a first metal layer, and a first insulating layer are sequentially disposed from the inside to the outside, and
the two second covers have a structure in which a second protective layer, a second metal layer, and a second insulating layer are sequentially disposed from the inside to the outside,
wherein the second metal layer has thermal conductivity greater than that of the first metal layer.

6. The secondary battery of claim 5, wherein the first metal layer is made of copper (Cu), and
the second metal layer is made of aluminum (Al).

7. A method for manufacturing a secondary battery, the method comprising:
disposing two first covers that cover both surfaces of an electrode assembly in a thickness direction, respectively, and disposing two second covers that cover both surfaces of the electrode assembly in a full-width direction, respectively;
forming a first sealing part that seals edge surfaces of the two first covers and the two second covers, to manufacture a semi-assembled pouch;
accommodating the electrode assembly in the semi-assembled pouch; and
forming a second sealing part that seals end surfaces of the two first covers and end surfaces of the two second covers which are directed in the same direction, to manufacture an assembled pouch,
wherein, when the electrode assembly is accommodated in the semi-assembled pouch in the accommodation process, the two second covers are in close contact with the surfaces of the electrode assembly in the full-width direction, respectively.

8. The method of claim 7, wherein the first sealing part is formed by sealing the edge surfaces of the two first covers with the edge surfaces of the two second covers which face each other.

9. The method of claim 7, wherein the second sealing part is formed by folding and inserting the end surfaces of the two second covers between the end surfaces of the two first covers and then thermally fusing the end surfaces of the two first covers to seal the end surfaces of the two first covers together with the end surfaces of the two second covers.

10. The method of claim 7, further comprising bending the first sealing part to be in close contact with a surface of the first cover.

11. The method of claim 10, wherein the bending process further comprises allowing the first sealing part to adhere to the surface of the first cover with an adhesive layer.

12. The method of claim 7, wherein the first cover has a structure in which a first protective layer, a first metal layer, and a first insulating layer are sequentially disposed from the inside to the outside, and the second cover has a structure in which a second protective layer, a second metal layer, and a second insulating layer are sequentially disposed from the inside to the outside,
wherein the second metal layer has thermal conductivity greater than that of the first metal layer.

13. A battery pack comprising a battery module in which the secondary battery of claim 1 is provided in plurality,
wherein the first covers of the secondary batteries are arranged to correspond to each other.

14. The battery pack of claim 13, further comprising a cooling member that cools the battery module,
wherein the cooling member is provided to be in close contact with the second covers of the secondary batteries.

15. The battery pack of claim 13, wherein a heat dissipation pad is further provided between the secondary batteries.
